(19) United States
(12) Patent Application Publication
(10) Pub. No.: US 2005/0240960 A1
(43) Pub. Date: Oct. 27, 2005

(54) Method and apparatus for controlling child's internet use

(76) Inventor: Martinus Nagtzaam, Grandville, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 10/831,737

(22) Filed: Apr. 23, 2004

(51) Int. Cl. H04N 7/167; H04N 7/18; H04N 7/16; G06F 17/30; G06F 7/00

(52) U.S. Cl. 725/28; 725/31; 725/81; 725/25

(57) ABSTRACT

A method and apparatus for inducing children to select appropriate programming over the Internet comprises providing a parent or other supervisor with equipment and software for monitoring Internet usage by the child's computer on a remote television set and providing the supervisor with a remote control device for disconnecting the child's computer from the Internet or disabling the child's computer completely if undesirable content is detected. The child's computer usage can be recorded and stored for later viewing. A controller can be set to permit time periods during which Internet usage is permitted.

### BACKGROUND OF THE INVENTION

With the unlimited and unconstrained content of materials available over the Internet, a serious concern on behalf of parents is the control of materials that their children access over the Internet. A number of filtering programs and systems exist that attempt to filter programs from viewing by means of keywords or the like or by screening out specific websites or images. Other programs and products make it possible to view the contents displayed on one computer from another computer for real-time monitoring. Other systems make it possible to store the images for later viewing.

A problem with filtering systems is that they do not work effectively. Some appropriate programs get filtered out, while other inappropriate programs pass through the filter. Identification and elimination of certain websites simply is ineffective at getting all offensive websites. In addition, filtering programs require that the user regularly access and load updates to stay abreast of the new hooks which are developed every day and aimed specifically at drawing children to inappropriate websites. Real-time monitoring programs require a significant level of computer knowledge and involve constant viewing and provide limited control capabilities.

An object of the present invention is to provide a simple, yet effective method and apparatus for inducing children to refrain from accessing websites with inappropriate content.

### BRIEF SUMMARY OF THE INVENTION

In accordance with the present invention, a method for inducing children to choose to view appropriate programming over the Internet comprises providing a parent or other supervisor with the ability to monitor real time Internet usage by the child's computer on a remote television set and providing the supervisor with the ability to disconnect the child's computer from the Internet or render the child's computer inoperable if undesirable content is detected. Another feature of the present invention is that a recording of the child's computer usage can be stored for later viewing on the television. The present invention can also include a controller for establishing permitted time periods during which Internet and computer usage is permitted.

### BRIEF DESCRIPTION OF DRAWINGS

FIG. 1 is a pictorial view showing the present invention connected in a home computer network.

FIG. 2 is a block diagram showing the connection of the present invention to the Internet via a DSL, cable, or phone modem, and transmission of the control signal to a television connected to a home cable TV network.

FIG. 3 is a block diagram showing a connection of the present invention in a cable network that handles both computer and cable television signals.

FIG. 4 is a software operational flow chart showing the automatic operation of the present invention for restricting Internet usage to predetermined periods of time.

FIG. 5 is a software operational flow chart showing the manual operation of the present invention for deactivating and reactivating the child's computer and Internet access.

FIG. 6 is a software operational flow chart showing the feature of the present invention whereby programming is recorded for later viewing.

### DETAILED DESCRIPTION OF PREFERRED EMBODIMENTS

The present invention is discussed below in connection with a method for teaching appropriate Internet use by children on a computer in the home by means of control devices such as a remote control, mouse, or a keyboard that are operated by a parent or other supervisor (both referred to as a supervisor) from a viewing station at a conventional television set.

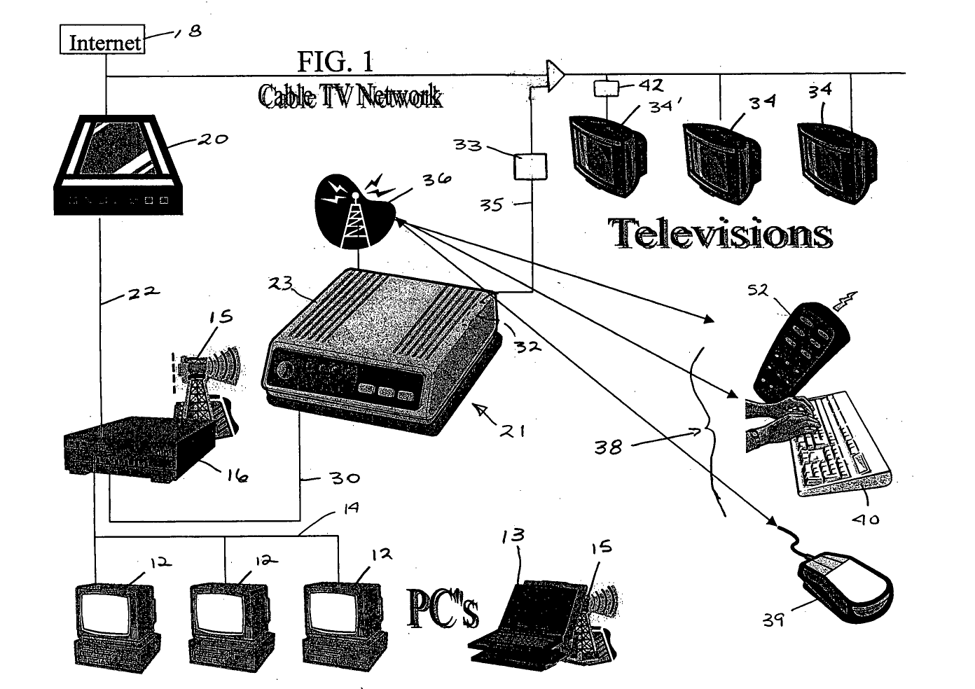

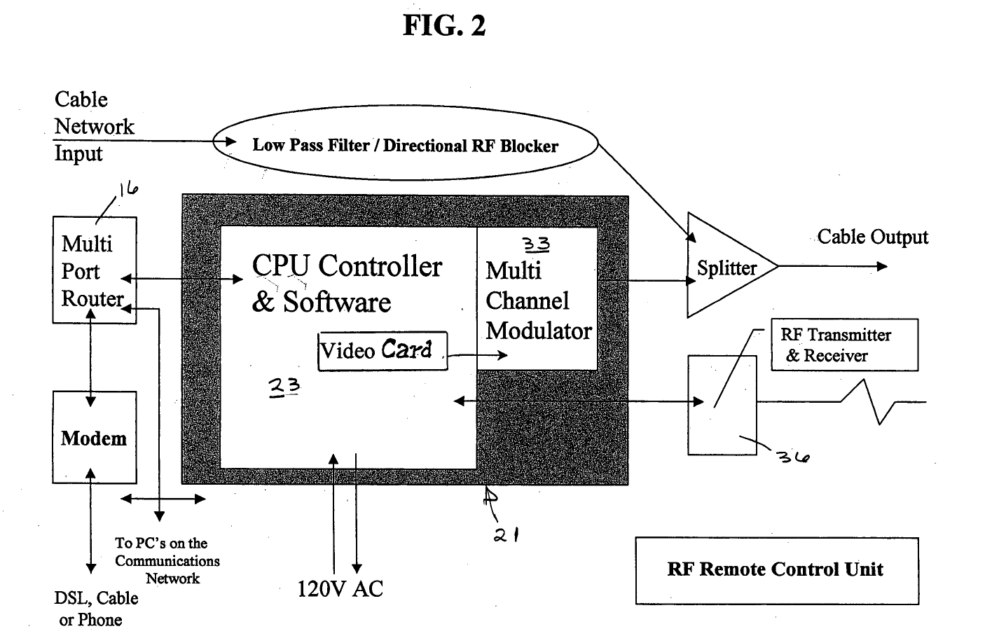

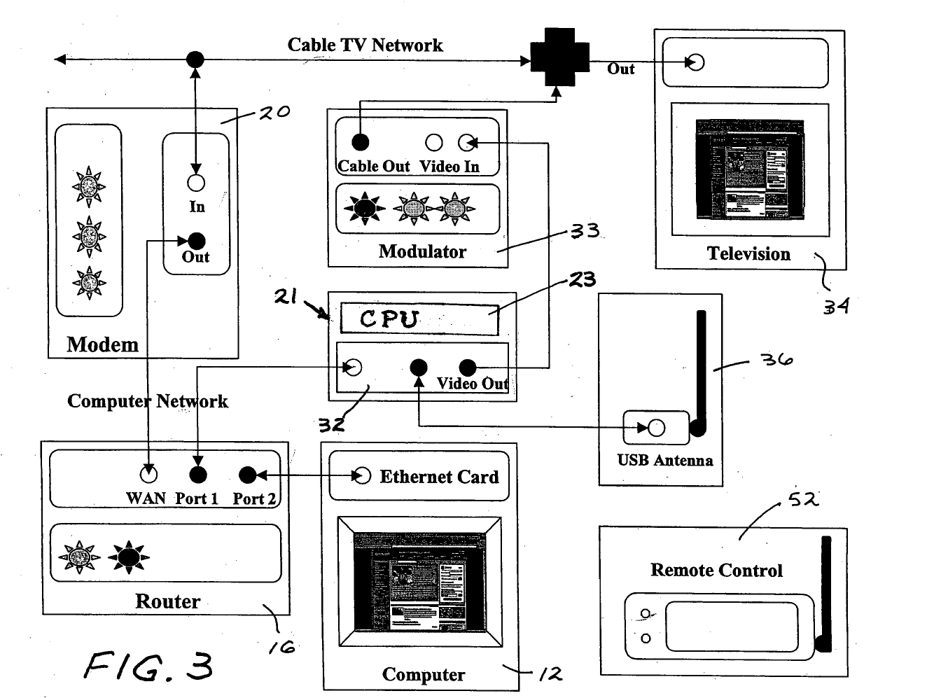

Referring to the drawings, a home computer network comprises one or more computers 12 that are operated by children. These computers may be in the bedroom of each child so that the child can operate the computer in private. The computers are connected by cables 14 or by a wireless connection to a home network router 16. In addition to desktop computers 12, a mobile computer, such as a lap top computer 13, can be connected to the home network router 16 by means of a wireless transmitter and receiver 15. Router 16 is connected to the Internet 18 by means of a cable modem 20 of conventional design by means of an appropriate conventional cable 22. A control module 21, comprising a CPU 23, and a video card 32, is connected to router 16 by means of a cable 30 or wireless connection. While a small modular unit is desired as the control module, the control module also could be a general purpose computer. Video card 32 is connected to a multi-channel modulator 33, such as a NetMedia Triple Play modulator. This may be incorporated in the control module (FIG. 2), or it can be a separate unit (FIGS. 1 and 3), wherein the modulator is connected to the video card by means of a cable 35. The modulator makes it possible to display the computer video signal on a selected channel of television sets 34. Television sets 34 thus act as monitors for the supervisor's computer.

The control module 21 is also provided with a wireless receiver 36 connected typically to a USB port in the module. The receiver receives input signals from USB RF transmitter 38, which is located at a viewing station at one of the television sets. The transmitter is portable and can be moved and operated from anywhere in the home. The transmitter can be any of a number of wireless control devices, such as remote control device 52, a mouse 39, a keyboard 40, or all three.

With the foregoing system, a supervisor positioned to watch television can still be in a position to control the supervisor's control module 21 (which may be located in some other room in the house) by means of wireless controls in his possession.

Thus far the components of the system are conventional. A home computer network can be set up with an available network system of the type provided by Linksys. A Linksys 802.11b point router is an acceptable router for the purposes of the present invention. A conventional digital cable modem such as an RCA digital cable modem is satisfactory. The various components can be connected by conventional computer cable, such as a category 3 cable. A Gyration Ultra cordless mouse, keyboard, and USB RF receiver are satisfactory wireless control devices. The control module 21 can employ any reasonably current CPU, such as a Pentium III or a Pentium IV, along with an Ethernet card (for Internet connection purposes). The control module also should include a video/graphics card with S-Video Out, such as a Mad Dog HEP card. Various components made by various manufacturers can be employed for the components of this system.

With the system set up as described above, the supervisor can view the video output of the control module on a television set by selecting an appropriate channel and can transmit control signals to the control module by means of a wireless remote, mouse, or keyboard at the television set. The control module may be in an upstairs bedroom, while the supervisor is controlling the control module from a television viewing room in the den on the first floor.

One way of setting up the television set to receive the computer display is to set the television set for receipt of the computer display on a particular channel of the television set. Another way of doing the same thing is to employ the picture-in-a-picture (PIP) function of some television sets, whereby a separate tuner 42 is connected to (or included in) the television set, so that the television set 34′ employs two tuners, one showing cable television programming and the other showing the computer output in a PIP screen in the comer of the main screen on the television set.

In the present invention, the supervisor is able to view not only the video output of the control module (or his own computer), but he is also able to view in real time the display on the child's computer that he is supervising. This is accomplished by means of a software program that enables computers connected in a network or over the Internet to view and control a remote computer. One such program for accomplishing this purpose is a program called PC Anywhere. PC Anywhere is installed on both the host (child's) computer and on the remote computer or control module 21 operated by the supervisor. The child's computers 12 are each provided with an individual IP address, preferably a static EP address (one that does not change). By appropriate set up procedures, the supervisor's computer or control module can view and control in real time the operation of any of the selected children's computers. The system is protected with adequate password protection to prevent the child from disconnecting the supervisor's computer. Therefore, whenever the child is on the computer, and particularly when the child is on the Internet, the supervisor can view on his television exactly what the child is looking at on his monitor in real time. With a PIP type television, the supervisor can continue to watch his favorite programming while keeping an eye on the child's computer usage.

By setting up the remote access programming so that the supervisor is the controller and providing adequate password protection to prevent a computer-savvy child from changing the settings of the system, the supervisor can view the computer activity of the child any time he wants, and if he feels that the Internet content that the child is viewing is inappropriate, the supervisor can simply disconnect the child from the Internet. This can be done without depriving the child of the ability to use the computer for non-Internet applications. If the supervisor wishes, the supervisor can blank the child's screen entirely or lock out the keyboard, so that the child can no longer use his computer at all.

These filtering or lock out functions are available with conventional programs. However, the use of such programs to lock out specific computers is somewhat complicated and technical in nature and involves multiple steps in connecting and disconnecting a user's access to the Internet. This process involves identifying the child's network IP address and removing or filtering (blocking) that address from the list of addresses that are permitted to receive Internet access through the router.

A feature of the present invention is a software user interface that simplifies the supervisor steps necessary to control the child's use of the Internet. When the supervisor views inappropriate material, he calls up a menu of authorized child computers, which are identified by the names of his children, for example, and checks a box or icon or otherwise enters a simple command to disconnect that computer from the Internet. That computer is instantly kicked off the Internet and cannot be reconnected to the Internet without permission from the supervisor. When the child is to be reconnected to the Internet, the supervisor simply calls up the same menu and enters the command to connect. At this point, the supervisor must also enter his secret password, so that the child cannot reconnect his own computer without permission.

The program of the present invention simplifies the somewhat complicated process available through existing programs and makes it as simple as entering a connect or disconnect instruction directed at a specifically identified computer.

In addition to making it possible to simply disconnect an child's computer from the Internet, under appropriate circumstances, the supervisor can effectively render the child's computer inoperable by locking out the keyboard and mouse or blanking the screen.

In addition, in the preferred practice of the present invention, the supervisor can establish permissible times and days during which the child's computer can be used to access the Internet. If, for example, a parent does not want the child to be on the Internet after 10:00 p.m., the program can be set to prohibit any Internet usage by the child's computer between 10:00 p.m. and 8:00 a.m. This operation is controlled by a timer of the type used in video cassette recorders for automatically programming the recording of television programs at specific times on specific days.

In another feature of the present invention, the supervisor's computer can be connected with a video tape or other data storage device, so that the child's computer usage can be taped or otherwise stored for later viewing by the supervisor. Programs exists for storing a plurality of snapshots of the child's computer usage at discreet time intervals in order to minimize the amount of storage space or memory necessary to record the child's computer usage over an extended period of time.

While the present invention does not purport to filter or block out inappropriate content so that the child cannot choose to receive inappropriate content, the child is always aware of the fact that a supervisor could be watching his computer monitor at any time without the child having any knowledge of this. The known fact that a supervisor could be watching the display on the child's computer as the child visits a website gives the child an opportunity to display the preferred behavior by exercising sound judgment and visiting appropriate sites in the first place.

The present invention is simple to set up, install, and operate, and yet gives the parent or supervisor an opportunity to monitor a child's use of the Internet whenever he wishes without having to engage in elaborate and time consuming investigation into which specific sites are inappropriate for viewing. The parent or supervisor can rely on the child to know what sites are inappropriate for viewing and to select not to view those sites in the first place. It is an easy matter to deprive a child of Internet privileges for a substantial period of time if the child chooses to select inappropriate material. The present invention provides an improved method of behavior modification over an arbitrary and ineffective filter system that simply makes it a challenge for the child to get around it. This is not to say that the present invention can be used only as an alternative to filtering programs. The present invention could be used in addition to filtering programs in appropriate circumstances.

Another feature of the invention is that the system can employ a special “key” for disconnecting a particular child's computer from control module supervision, when the supervisor wishes to use the child's computer in private. This key can be incorporated in software included in a software module that can be connected at will to the desired computer. Preferably this can be done by a memory device, such as a flash memory, incorporated in a USB module that connects to the USB port of the child's computer. A 128 MB Lexar Media Jump Drive can be used. This should be secure or able to be password protected. If a supervisor wishes to use a computer on the network in private, the supervisor can plug in the USB module, sign on with the password, and select the “Bypass” option. Whatever the supervisor thereafter views or hears is then in private. The computer can be returned to control module supervision as soon as the USB module is removed. No other setting or changes need be made to re-initialize all the features in this mode. If the computer display was previously disabled, it will remain disabled until the control module is accessed. The USB module also can be used to enter in the child's computer the PC Anywhere or like programming necessary for the control of the child's computer by the control module.

Block diagrams showing possible ways to implement the present invention are shown in FIGS. 2 and 3. In FIG. 2, the computers are connected to the Internet by cable, DSL, or a phone modem, while the television receives its programming through a cable connection.

In FIG. 3, a network employing a cable TV as well as a cable modem is shown. One difference in the embodiment of FIG. 3 and the embodiment of FIG. 1, is that instead of using a television-type remote control device or a mouse or keyboard, the remote control could be a specially adapted control panel 52 that has specifically designated elements, such as a mouse, buttons, toggle switches, or a touch screen display for actuating the various control actions desired.

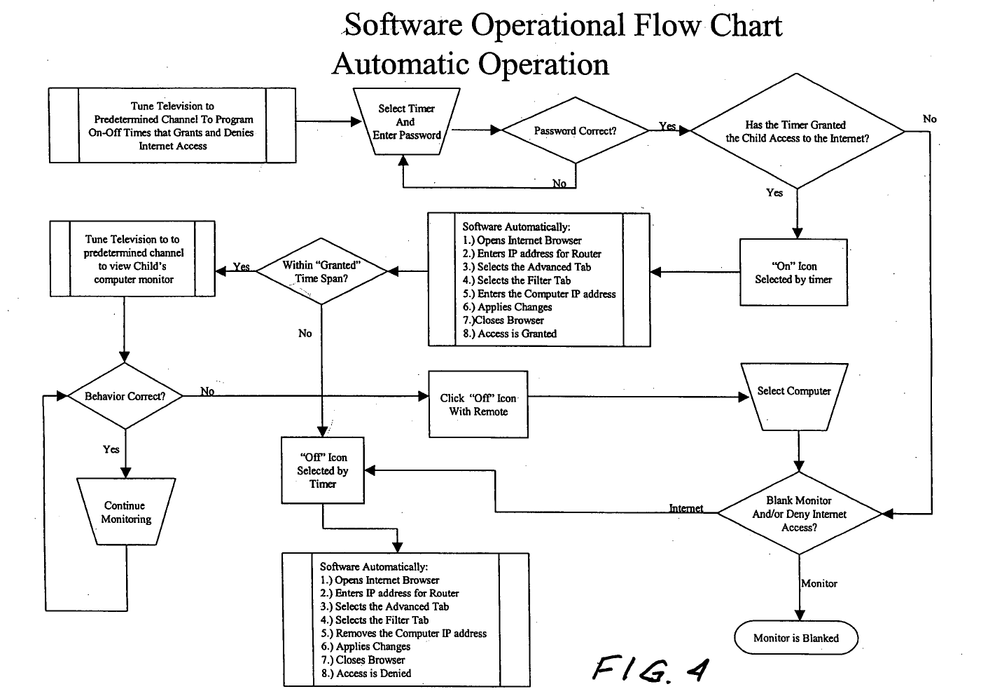

Flow charts showing the implementation of the software of the present invention are shown in FIGS. 4-6.

Referring to the flow chart in FIG. 4, in order to set the system for automatic operation, where Internet access is allowed at specific times, the television is first tuned a to a predetermined channel to program the on/off times that grant and deny Internet access. This can be done by selecting the timer, entering a password, and entering the appropriate times for the child's use of the Internet. When this done, the child can only use the Internet during the designated time period.

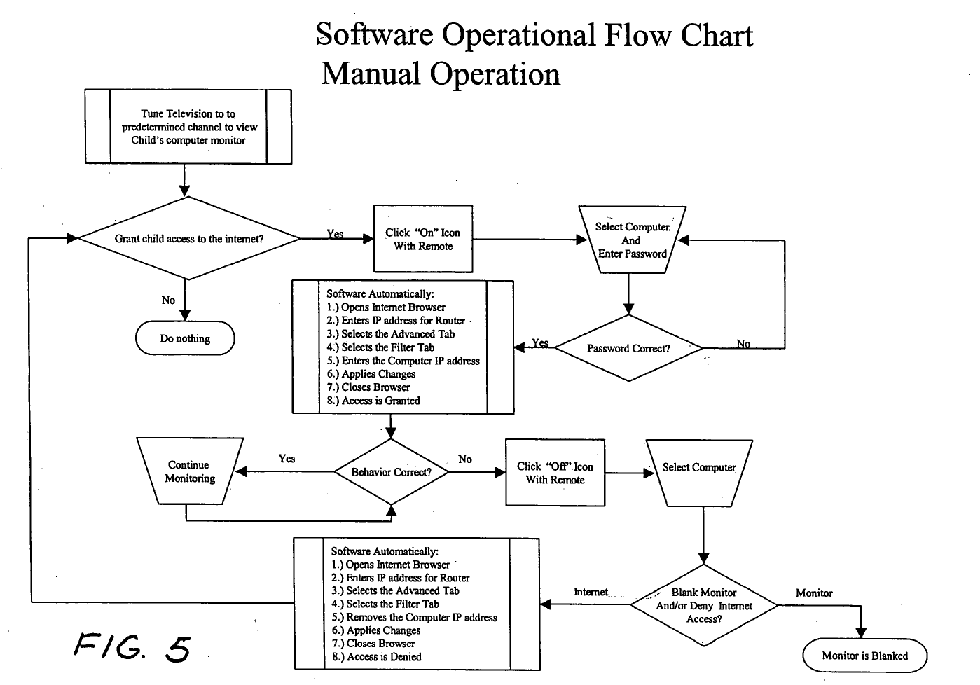

A flow chart for manual operation of the software is disclosed in FIG. 5. In this case, the television is tuned to the predetermined channel (or tuned to the PIP setting). The parent can then click an icon for “access granted” or an icon for “access denied” that appears on the screen with a remote control device in order to authorize the child to use his computer for Internet access. The parent must enter the parent's password after entering the instruction to turn the child's computer Internet usage on. By requiring the password after the instruction is entered, the default for the instruction is “off” and there is no possibility that a child can later turn his computer usage on because the parent forgot to logoff his control module.

As the flowchart indicates, when computer usage is inappropriate, the parent can either disconnect the child's computer from the Internet or blank the screen or deactivate the keyboard of the child's computer completely.

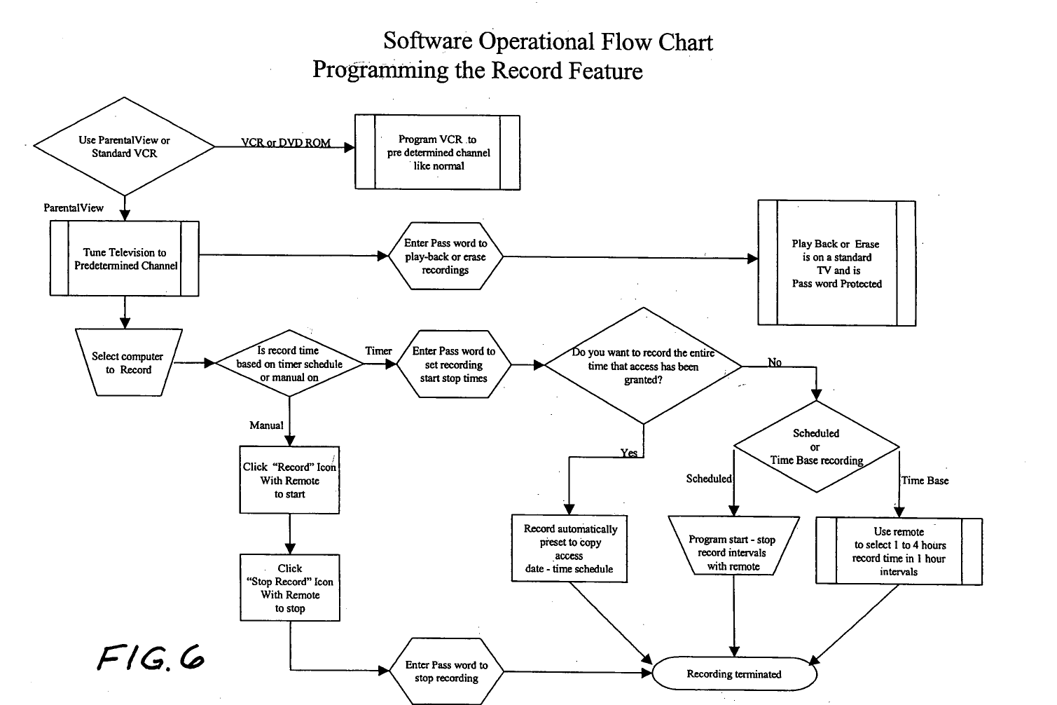

The manner in which the record feature is programmed is shown in FIG. 6. A VCR hardware or DVD burner can be used to record periodic segments or the entire computer usage of the child. Like a VCR, the record times can be programmed so that the parent can choose to program only a portion of the time during which the child has authorization to use the Internet.

It should be understood that the foregoing is merely exemplary of the preferred practice of the present invention and that various changes and modifications in the arrangements and details of construction and operation of the present invention can be made without departing from the spirit and scope of the present invention.

1. A method for inducing a child to refrain from viewing inappropriate content on the Internet comprising:
connecting the child's computer in a home network by means of a router that can control access to the Internet by individual computers;
connecting the router to the Internet;
providing a control module for a supervisor, the control module including a CPU and a video card, and connecting the control module to the home network;
providing software programming for the child's computer and the control module that provides real-time access by the supervisor's control module to the child's computer, such that the control module can monitor the actual computer usage on the child's computer;
providing at least one television set for viewing by the supervisor;
providing a modulator for the supervisor's control module that makes it possible to view the video output of the control module on the television set, and operably connecting the modulator to the television set;
providing a wireless controller that makes it possible to control the control module by means of one or more of a mouse, keyboard, or other remote control device through a wireless connection from a viewing station at the television set; and
providing a software program viewable on the television set that makes it possible for the supervisor to select the child's computer and initiate controls to disconnect the child's computer from the Internet when inappropriate Internet usage is detected by the supervisor.

2. A method as in claim 1 and further comprising disconnecting the child's computer from the Internet with the wireless controller when inappropriate content is detected on the child's computer.

3. A method as in claim 1 and further comprising providing a programmable timer that can be set by the supervisor to allow the child to use the Internet only at pre-selected times or days.

4. A method as in claim 1 wherein the computers are connected to the Internet by means of a cable or DSL connection or by a phone modem.

5. A method as in claim 1 wherein the software permits the supervisor to connect or disconnect a computer from the Internet by adding or deleting the computer from authorized stations on the home network router.

6. A method as in claim 5 wherein the software requires that the supervisor enter a password after the supervisor enters a connect instruction but not after a disconnect instruction.

7. Control apparatus for inducing a child to refrain from viewing inappropriate content on the Internet, wherein the child's computer is connected in a home network by means of a router that can control access to the Internet by individual computers, the router in turn being connected to the Internet, the control apparatus including:
a control module for a supervisor, the control module including a CPU and a video card, the control module being connected to the home network, the control module and child's computer being programmed to provide real-time access by the control module to the child's computer, such that the control module can monitor the actual computer usage on the child's computer;
at least one television set for viewing by the supervisor;
a modulator interconnecting to the control module video card and the television set such that the video output of the control module can be viewed on the television set;
a wireless controller for controlling the operation of the control module, the wireless controller including one or more of a mouse, keyboard, or other remote control device, the controller being connected through a wireless connection that is operable from a viewing station at the television set; and
control software installed on the control module and child's computer that makes it possible for the supervisor to select the child's computer and initiate controls to disconnect the child's computer from the Internet when inappropriate Internet usage is detected on the television set by the supervisor.

8. Control apparatus as in claim 1 and further comprising means for disconnecting the child's computer from the Internet with the wireless controller when inappropriate content is detected on the child's computer.

9. Control apparatus as in claim 1 and further comprising a programmable timer connected to the control module that can be set by the supervisor to allow the child to use the Internet only at pre-selected times or days.

10. Control apparatus as in claim 1 wherein the computers are connected to the Internet by means of a cable or DSL connection or by a phone modem.

11. Control apparatus as in claim 1 wherein the software permits the supervisor to connect or disconnect a computer from the Internet by adding or deleting the computer from authorized stations on the home network router.

12. Control apparatus as in claim 5 wherein the software requires that the supervisor enter a password after the supervisor enters a connect instruction.
